(19) United States
(12) Patent Application Publication
(10) Pub. No.: US 2008/0280074 A1
(43) Pub. Date: Nov. 13, 2008

(54) PRESSURE-SENSITIVE ADHESIVE OPTICAL FILM AND IMAGE DISPLAY

(75) Inventors: Akiko SUGINO, Osaka (JP); Kohei YANO, Osaka (JP); Tsuyoshi CHIBA, Osaka (JP); Masayuki SATAKE, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Osaka (JP)

(21) Appl. No.: 12/114,275

(22) Filed: May 2, 2008

(30) Foreign Application Priority Data
May 8, 2007 (JP) 2007-123581

(51) Int. Cl. B32B 7/12; C09K 19/00

(52) U.S. Cl. 428/1.55; 428/355 AC

(57) ABSTRACT

A pressure-sensitive adhesive optical film of the present invention comprises an optical film; and a pressure-sensitive adhesive layer laminated on at least one side of the optical film, wherein the pressure-sensitive adhesive layer is formed from a pressure-sensitive adhesive containing a (meth)acrylic polymer (A) and a resin component (B) having an aromatic ring structure in its main chain. The pressure-sensitive adhesive optical film has durability and can be prevented from causing display unevenness in a peripheral portion of a display screen.

### BACKGROUND OF THE INVENTION

1. Field of the Present Invention

The present invention relates to a pressure-sensitive adhesive optical film. The present invention also relates to an image display, such as a liquid crystal display, an organic electroluminescent display, a cathode ray tube (CRT), and a plasma display panel (PDP), using the pressure-sensitive adhesive optical film.

The pressure-sensitive adhesive optical film of the present invention may have a discotic liquid crystal layer to serve as a useful optical compensation film for improving display contrast and the viewing angle characteristics for displayed colors. When the pressure-sensitive adhesive optical film of the present invention is a laminate including a polarizer, it is useful as an elliptically polarizing plate with an optical compensation function.

2. Description of the Related Art

Liquid crystal displays are attracting attention because of their features such as slimness, lightweight and low power consumption and widely used in portable equipment such as cellular phones and watches, office automation equipment such as personal computer monitors and notebook computers, domestic electrical equipment such as video cameras and liquid crystal televisions, and so on. Liquid crystal displays are placed under various conditions such as hot conditions and humid conditions and thus required to have high durability such that display quality degradation can be prevented even under such conditions. When liquid crystal displays are placed under hot or humid conditions, however, residual stress associated with a change in the size of the substrate causes a problem in which display unevenness can occur in the peripheral portion of the liquid crystal panel.

In order to reduce the display unevenness in the peripheral portion, some methods have been proposed that include using a pressure-sensitive adhesive composition containing a plasticizer and an oligomer component to form a pressure-sensitive adhesive optical film (see for example Japanese Patent Application Laid-Open (JP-A) No. 08-95032, Japanese Patent No. 2767382, JP-A No. 09-87593 and JP-A No. 10-279907) or using a pressure-sensitive adhesive composition containing an acrylic pressure-sensitive adhesive and a urethane elastomer (see for example JP-A No. 2005-194366).

However, the pressure-sensitive adhesive compositions disclosed in JP-A No. 08-95032, Japanese Patent No. 2767382, JP-A No. 09-87593 and JP-A No. 10-279907 have a problem in which the additive such as the plasticizer and the oligomer component can be precipitated to cause defects in appearance or degradation of the pressure-sensitive adhesive in a long-time heating test. In some cases, an adverse infection on durability has been observed in a hot or humid environment. On the other hand, the pressure-sensitive adhesive composition disclosed in JP-A No. 2005-194366 can solve the problem of the precipitation, but its stress relaxation capability is not sufficient, and, therefore, it is not at a satisfactory level in view of display unevenness and durability.

### SUMMARY OF THE PRESENT INVENTION

It is an object of the present invention to provide a pressure-sensitive adhesive optical film that includes an optical film and a pressure-sensitive adhesive layer laminated on at least one side of the optical film and has durability and can be prevented from causing display unevenness in a peripheral portion of a display screen.

It is another object of the present invention to provide an image display using the pressure-sensitive adhesive optical film.

As a result of investigation for solving the problems, the inventors have found that the objects can be achieved with the pressure-sensitive adhesive optical film described below, and has finally completed the present invention.

The present invention relates to a pressure-sensitive adhesive optical film, comprising:

an optical film; and

a pressure-sensitive adhesive layer laminated on at least one side of the optical film,

wherein the pressure-sensitive adhesive layer is formed from a pressure-sensitive adhesive containing a (meth)acrylic polymer (A) and a resin component (B) having an aromatic ring structure in its main chain.

In the pressure-sensitive adhesive optical film, the pressure-sensitive adhesive preferably contains 20 to 200 parts by weight of the resin component (B) having an aromatic ring structure in its main chain based on 100 parts by weight of the (meth)acrylic polymer (A).

In the pressure-sensitive adhesive optical film, the resin component (B) having an aromatic ring structure in its main chain is preferably a polyurethane resin, a polyimide resin and/or a polycarbonate resin.

In the pressure-sensitive adhesive optical film, the pressure-sensitive adhesive preferably further contains 0.1 to 10 parts by weight of (C) an isocyanate crosslinking agent and 0.01 to 0.5 part by weight of (D) a silane coupling agent, based on 100 parts by weight of the (meth)acrylic polymer (A).

In the pressure-sensitive adhesive optical film, the pressure-sensitive adhesive layer is preferably laminated on the optical film with an undercoat layer interposed therebetween, and the undercoat layer contains a polymer (E), wherein the polymer (E) is a primary amino group-containing polymer.

In the pressure-sensitive adhesive optical film, the primary amino group-containing polymer is preferably a poly(meth)acrylate ester having a primary amino group at its end.

In the pressure-sensitive adhesive optical film, the undercoat layer preferably comprises 0.01 to 500 parts by weight of an antioxidant based on 100 parts by weight of the polymer (E).

In the pressure-sensitive adhesive optical film, the antioxidant is preferably at least one selected from a phenolic antioxidant, a phosphorus antioxidant, a sulfur antioxidant, and an amine antioxidant.

In the pressure-sensitive adhesive optical film, the optical film preferably comprises a transparent base film and a discotic liquid crystal layer provided on one side of the transparent base film, and the pressure-sensitive adhesive layer is preferably provided on the discotic liquid crystal layer with the undercoat layer interposed therebetween. The undercoat layer is preferably formed from a polyethyleneimine material.

In the pressure-sensitive adhesive optical film, the optical film preferably further comprises a polarizer that is provided on one side of the transparent base film on which the discotic liquid crystal layer is not provided.

The present invention also relates to an image display, comprising at least one piece of the above pressure-sensitive adhesive optical film.

The pressure-sensitive adhesive optical film of the present invention includes an optical film and a pressure-sensitive adhesive layer laminated on at least one side of the optical film. In this structure, the pressure-sensitive adhesive layer is formed from a pressure-sensitive adhesive comprising a polymer blend (polymer mixture) containing a (meth)acrylic polymer (A) and a resin component (B) having an aromatic ring structure in its main chain as a base polymer, so that it can be prevented from causing display unevenness in a peripheral portion of a display screen. Because of this excellent effect, it is particularly preferred when the pressure-sensitive adhesive optical film contains a discotic liquid crystal layer having function as an optical compensation layer.

In the pressure-sensitive adhesive optical film of the present invention, the pressure-sensitive adhesive layer is formed from a pressure-sensitive adhesive comprising a polymer blend (polymer mixture) containing a (meth)acrylic polymer (A) and a resin component (B) having an aromatic ring structure in its main chain as a base polymer, so that it can be prevented from causing display unevenness in a peripheral portion. In contrast to conventional pressure-sensitive adhesives containing a base polymer and additives such as a plasticizer, the pressure-sensitive adhesive according to the present invention can be free from degradation of itself or degradation of appearance caused by precipitation of additives. According to conventional techniques, for example, when 20 parts by weight or more of polyurethane elastomer is contained based on 100 parts by weight of a pressure-sensitive adhesive base polymer, a mixture can be whitened, and, therefore, it has been difficult to find optical applications for such a mixture. However, it has been found that if a pressure-sensitive adhesive comprising a blend containing a certain amount of the resin component (B) having an aromatic ring structure in its main chain is used according to the present invention, a pressure-sensitive adhesive optical film having excellent performance with respect to durability and peripheral unevenness can be obtained.

### BRIEF DESCRIPTION OF THE DRAWINGS

FIG. 1 is a cross-sectional view of an example of the pressure-sensitive adhesive optical film of the present invention; and

FIG. 2 is a cross-sectional view of another example of the pressure-sensitive adhesive optical film of the present invention.

### DETAILED DESCRIPTION OF THE PREFERRED EMBODIMENTS

Embodiments of the present invention are described in detail below.

According to the present invention, the pressure-sensitive adhesive optical film includes an optical film and a pressure-sensitive adhesive layer laminated on at least one side of the optical film, wherein the pressure-sensitive adhesive layer includes a pressure-sensitive adhesive containing a (meth)acrylic polymer (A) and a resin component (B) having an aromatic ring structure in its main chain.

Some embodiments of the present invention are described below by illustrating, with reference to the drawings, cases where a discotic liquid crystal layer is provided.

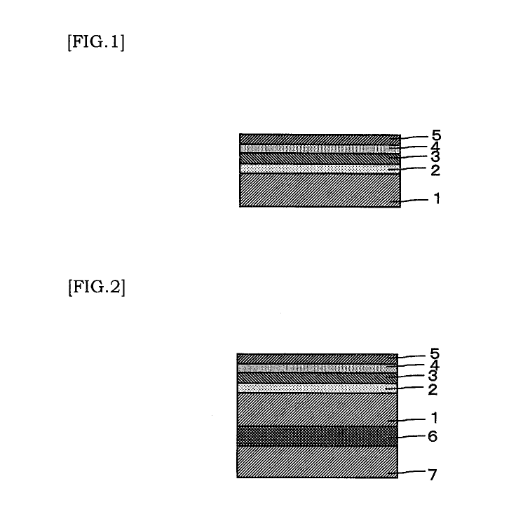

Referring to FIG. 1, a pressure-sensitive adhesive optical film includes a transparent base film 1, a discotic liquid crystal layer 3 provided on one side of the base film 1, and a pressure-sensitive adhesive layer 5 provided on the discotic liquid crystal layer 3 with an undercoat layer 4 interposed therebetween. FIG. 1 shows a case where an alignment film 2 is placed between the transparent base film 1 and the discotic liquid crystal layer 3. However, using the alignment film 2 may be replaced with rubbing one side of the transparent base film 1.

FIG. 2 shows a case where a polarizer 6 and then a transparent protective film 7 are placed on the other side, where the discotic liquid crystal layer 3 is not provided, of the transparent base film 1 in the structure of the pressure-sensitive adhesive optical film of FIG. 1. In FIG. 2, the transparent base film 1 also serves as a transparent protective film for the polarizer 6.

Various types of transparent materials may be used for the transparent base film. For example, polyester type polymers, such as polyethylene terephthalate and polyethylenenaphthalate; cellulose type polymers, such as diacetyl cellulose and triacetyl cellulose; acrylics type polymer, such as poly methylmethacrylate; styrene type polymers, such as polystyrene and acrylonitrile-styrene copolymer (AS resin); polycarbonate type polymer may be mentioned. Besides, as examples of the polymer forming the base film, polyolefin type polymers, such as polyethylene, polypropylene, polyolefin that has cyclo-type or norbornene structure, ethylene-propylene copolymer; vinyl chloride type polymer; amide type polymers, such as nylon and aromatic polyamide; imide type polymers; sulfone type polymers; polyether sulfone type polymers; polyether-ether ketone type polymers; poly phenylene sulfide type polymers; vinyl alcohol type polymer; vinylidene chloride type polymers; vinyl butyral type polymers; arylate type polymers; polyoxymethylene type polymers; epoxy type polymers; or blend polymers of the above-mentioned polymers may be mentioned.

Moreover, as is described in Japanese Patent Laid-Open Publication No. 2001-343529 (WO 01/37007), polymer films, for example, resin compositions including (A) thermoplastic resins having substituted and/or non-substituted imido group is in side chain, and (B) thermoplastic resins having substituted and/or non-substituted phenyl and nitrile group in sidechain may be mentioned. As an illustrative example, a film may be mentioned that is made of a resin composition including alternating copolymer comprising iso-butylene and N-methyl maleimide, and acrylonitrile-styrene copolymer. A film comprising mixture extruded article of resin compositions etc. may be used.

In general, a thickness of the transparent base film, which can be determined arbitrarily, is 1 to 500 μm, especially 5 to 200 μm in viewpoint of strength, work handling and thin layer.

The transparent base film is preferably as colorless as possible. Thus, the transparent base film is preferably used which has a film-thickness-direction retardation of −90 nm to +75 nm, wherein the retardation (Rth) is represented by the formula: Rth=[(nx+ny)/(2−nz)]d, wherein nx and ny are each a principal refractive index in the plane of the film, nz is a refractive index in the film-thickness direction, and d is the thickness of the film. If the transparent base with such a thickness-direction retardation value (Rth) of −90 nm to +75 nm is used, coloring (optical coloring) of the polarizing plate can be almost avoided, which could otherwise be caused by any other transparent base film. The thickness-direction retardation (Rth) is more preferably from −80 nm to +60 nm, particularly preferably from −70 nm to +45 nm.

As the transparent base film, if polarization property and durability are taken into consideration, cellulose based polymer, such as triacetyl cellulose and norbornene based polymer, are preferable, and especially cellulose based polymer, such as triacetyl cellulose is suitable.

The discotic liquid crystal layer is useful as an optical compensation layer and can increase viewing angle, contrast, brightness, and the like. The discotic liquid crystal compound having a polymerizable unsaturated group can form a discotic liquid crystal layer, when the compound is aligned and cured. In a preferred mode, the discotic liquid crystal compound is obliquely aligned in the discotic liquid crystal layer. The thickness of the discotic liquid crystal layer is generally from about 0.5 to about 10 μm.

Discotic liquid crystal compounds have negative refractive index anisotropy (uniaxiality). Examples thereof include benzene derivatives as described in the research report by C. Destrade et al., Mol. Cryst. vol. 71, p. 111 (1981); cyclohexane derivatives as described in the research report by B. Kohne et al., Angew. Chem., vol. 96, p. 70 (1984); and azacrown or phenylacetylene type macrocyclic compounds as described in the research report by J. M. Lehn et al., J. Chem. Commun., p. 1794 (1985) and the research report by J. Zhang et al., J. Am. Chem. Soc., vol. 116, p. 2655 (1994). Discotic liquid crystal compounds may generally have a structure in which any of them forms a core at the center of the molecule and has radially provided straight substituents such as straight alkyl or alkoxy groups and substituted benzoyloxy groups. Discotic liquid crystal compounds include compounds that exhibit liquid crystal properties and are generally called “discotic liquid crystal.” It will be understood that discotic liquid crystal compounds are not limited to the above and include any molecule that has negative uniaxiality and can be oriented in a certain degree. In the present invention, the discotic liquid crystal compound may have a polymerizable unsaturated group, such as an acryloyl, methacryloyl, vinyl, or allyl group, and capable of causing a curing reaction by means of heat, light or the like. In the discotic liquid crystal layer, the final product is not necessarily the above-described compound and may include substances that have been polymerized or crosslinked by the reaction of the polymerizable unsaturated group and lost the liquid crystal properties by polymerization.

Discotic liquid crystal compounds encompasses not only various types of discotic liquid crystal compounds but also the whole of compounds whose molecule has optically-negative uniaxiality by itself, such as reaction products of discotic liquid crystals, which have already lost liquid crystal properties due to reaction with any other low-molecular-weight compound or polymer.

Alignment treatment of the discotic liquid crystal may be performed by rubbing the surface of the transparent base film or using an alignment film. Examples of the alignment film include obliquely vapor-deposited inorganic films and specific rubbed organic polymer films. Examples thereof also include thin films in which molecules are isomerized by light and uniformly arranged in a certain direction, such as LB films comprising azobenzene derivatives. Examples of organic alignment films include polyimide films and organic polymer films having a hydrophobic surface, such as alkyl chain-modified polyvinyl alcohol, polyvinyl butyral, or poly methylmethacrylate. Obliquely vapor-deposited inorganic films include obliquely vapor-deposited SiO films.

The discotic liquid crystal compound may be obliquely aligned. For example, a method that may be used for the alignment includes forming an alignment film on the transparent base film, then applying the discotic liquid crystal compound, which is polymerizable liquid crystal compound, thereto so that the compound is obliquely aligned, and then fixing the compound by application of light such as ultraviolet light or heat. Alternatively, the discotic liquid crystal may be obliquely aligned on any other alignment substrate and then transferred to the transparent support by the use of an optically-transparent adhesive or pressure-sensitive adhesive to form the discotic liquid crystal compound.

The discotic liquid crystal layers disclosed in Patent Literature (JP-A No. 08-95032 and JP-B No. 2767382) are preferably used. Wide View films manufactured by Fuji Photo Film Co., Ltd. have such an obliquely-aligned discotic liquid crystal layer formed on a cellulose polymer film.

The undercoat layer is preferably formed from a material that has good adhesion to both the pressure-sensitive adhesive layer and the discotic liquid crystal layer and can form a film with a high strength. Materials that have such properties and may be used include various polymers (E), and metal oxide sols, silica sols and so on. In particular, polymers are preferably used.

Examples of the polymers (E) include polyurethane resins, polyester resins, and polymers having an amino group in their molecule. The polymer s (E) to be used may be in any of a solvent-soluble form, a water-dispersible form and a water-soluble form. For example, water-soluble polyurethanes, water-soluble polyesters, water-soluble polyamides, and the like, and water-dispersible resins, such as ethylene-vinyl acetate copolymer emulsions and (meth)acrylic polymer emulsions, may be used. Water-dispersible types that may be used include emulsions produced by emulsifying various resins such as polyurethanes, polyesters and polyamides with an emulsifying agent; and self-emulsified products produced by introducing a water-dispersible hydrophilic anionic, cationic or nonionic group into any of the above resins. Ionic polymer complexes may also be used.

When the pressure-sensitive adhesive layer contains an isocyanate compound, the polymers (E) preferably has a functional group reactive with the isocyanate compound. Such a polymer preferably has an amino group in its molecule. In particular, a polymer having a primary amino group at its end is preferably used. Such a polymer reacts with the isocyanate compound to produce strong adhesion.

Examples of the polymer having an amino group in its molecule include polyethyleneimines, polyallylamines, polyvinylamines, polyvinylpyridines, polyvinylpyrrolidines, and polymers of amino group-containing monomers such as dimethylaminoethyl acrylate. In particular, polyethyleneimines are preferred. Any type of polyethyleneimine material having a polyethyleneimine structure may be used, and examples thereof include polyethyleneimine and ethyleneimine adducts and/or polyethyleneimine adducts of polyacrylate.

Various types of polyethyleneimine may be used without limitation. The weight average molecular weight of the polyethyleneimine is generally, but not limited to, from about 100 to about 1,000,000. Commercially available examples of the polyethyleneimine include Epomin SP series (such as SP-003, SP006, SP012, SP018, SP103, SP110, and SP200) and Epomin P-1000 manufactured by Nippon Shokubai Co., Ltd. Epomin P-1000 is particularly preferred.

Ethyleneimine adducts and/or polyethyleneimine adducts of polyacrylate may be obtained by emulsion polymerization of alkyl(meth)acrylate for forming a base polymer (acrylic polymer) of the acrylic pressure-sensitive adhesive described later and another monomer copolymerizable therewith in a conventional manner. The copolymerizable monomer to be used has a functional group such as a carboxyl group such that it can react with ethyleneimine or the like. The content of the monomer having such a functional group as carboxyl may be appropriately adjusted depending on the content of ethyleneimine or the like for the reaction. A styrene type monomer is preferably used as the copolymerizable monomer. The carboxyl group or the like in an acrylate may be allowed to react with a separately synthesized polyethyleneimine so that adducts grafted with polyethyleneimine can be produced. Commercially available examples thereof include Polyment NK-380 manufactured by Nippon Shokubai Co., Ltd.

Ethyleneimine adducts and/or polyethyleneimine adducts of acrylic polymer emulsions may also be used. Commercially available examples thereof include Polyment SK-1000 manufactured by Nippon Shokubai Co., Ltd.

In the process of forming the undercoat layer, an amino group-containing polymer and a compound capable of reacting with the amino group-containing polymer may be mixed and crosslinked with each other so that the strength of the undercoat layer can be improved. Specifically, examples of the compound capable of reacting with the amino group-containing polymer may include an epoxy compound or the like.

When the undercoat layer is provided, the pressure-sensitive adhesive layer may be formed after the undercoat layer is formed on the optical film. For example, an undercoat solution such as an aqueous polyethyleneimine solution may be applied by an application method such as coating, dipping and spraying and then dried to form an undercoat layer. The thickness of the undercoat layer is preferably from about 10 to about 5000 nm, more preferably from 50 to 500 nm. If the undercoat layer is too thin, it cannot have properties as a bulk or cannot exhibit sufficient strength so that adequate adhesion cannot be achieved in some cases. If it is too thick, degradation in the optical properties can be caused.

According to the present invention, the pressure-sensitive adhesive layer is formed from a pressure-sensitive adhesive containing a (meth)acrylic polymer (A) and a resin component (B) having an aromatic ring structure in its main chain.

A polymer blend (polymer mixture) containing the (meth)acrylic polymer (A) and the resin component (B) having an aromatic ring structure in its main chain as a base polymer may be used for the pressure-sensitive adhesive to form the pressure-sensitive adhesive layer.

While the (meth)acrylic polymer (A) may be of any appropriate type, as long as the effects of the present invention are not impaired, it is preferably a (meth)acrylic polymer having alkyl(meth)acrylate as a major monomer unit. As used herein, the term “(meth)acrylate” refers to acrylate and/or methacrylate, and “(meth)” is used herein in the same sense.

In the alkyl(meth)acrylate, the alkyl group may have about 1 to about 18 carbon atoms, preferably 1 to 9 carbon atoms and may be any of a straight chain and a branched chain. Examples of the alkyl(meth)acrylate includes methyl (meth)acrylate, ethyl(meth)acrylate, propyl(meth)acrylate, isopropyl(meth)acrylate, n-butyl(meth)acrylate, isobutyl(meth)acrylate, pentyl(meth)acrylate, hexyl (meth)acrylate, 2-ethylhexyl(meth)acrylate, n-octyl(meth)acrylate, isooctyl (meth)acrylate, decyl(meth)acrylate, dodecyl(meth)acylate, lauryl(meth)acrylate, and stearyl(meth)acrylate. These may be used singly or in any combination. The average number of carbon atoms in the alkyl group is preferably from 4 to 12.

The content of the alkyl(meth)acrylate monomer unit in the (meth)acrylic polymer may be from 50 to 100% by weight, preferably from 60 to 100% by weight, more preferably from 70 to 100% by weight.

The (meth)acrylic polymer may also contain other monomer unit derived from any monomer component other than the alkyl(meth)acrylate.

Examples of the other monomer component include hydroxyl group-containing monomers such as 2-hydroxyethyl(meth)acrylate, 2-hydroxypropyl (meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl (meth)acrylate, and (4-hydroxymethylcyclohexyl)-methyl acrylate; carboxyl group-containing monomers such as (meth)acrylic acid, carboxyethyl(meth)acrylate, carboxypentyl(meth)acrylate, itaconic acid, maleic acid, fumaric acid, and crotonic acid; acid anhydride group-containing monomers such as maleic anhydride and itaconic anhydride; caprolactone adducts of acrylic acid; sulfonic acid group-containing monomers such as allylsulfonic acid, 2-(meth)acrylamido-2-methylpropanesulfonic acid, (meth)acrylamidopropanesulfonic acid, and sulfopropyl(meth)acrylate; and phosphate group-containing monomers such as 2-hydroxyethylacryloyl phosphate.

Examples of the other monomer component also include nitrogen-containing vinyl monomers. Examples of such monomers for the purpose of modification include maleimide; (N-substituted) amide monomers such as (meth)acrylamide, N,N-dimethyl(meth)acrylamide, N,N-diethyl(meth)acrylamide, N-hexyl(meth)acrylamide, N-methyl(meth)acrylamide, N-butyl(meth)acrylamide, N-methylol(meth)acrylamide, and N-methylolpropane(meth)acrylamide; alkylaminoalkyl(meth)acrylate monomers such as aminoethyl(meth)acrylate, aminopropyl(meth)acrylate, N,N-dimethylaminoethyl(meth)acrylate, and tert-butylaminoethyl (meth)acrylate; alkoxyalkyl(meth)acrylate monomers such as methoxyethyl(meth)acrylate and ethoxyethyl(meth)acrylate; and succinimide monomers such as N-(meth)acryloyloxymethylenesuccinimide, N-(meth)acryloyl-6-oxyhexamethylenesuccinimide, and N-(meth)acryloyl-8-oxyoctamethylenesuccinimide.

Examples of the other monomer component also include vinyl monomers such as vinyl acetate, vinyl propionate, N-vinylcarboxylic acid amides, styrene, α-methylstyrene, and N-vinylcaprolactam; nitrile monomers such as acrylonitrile and methacrylonitrile; epoxy group-containing acrylic monomers such as glycidyl (meth)acrylate; glycol acrylate monomers such as polyethylene glycol (meth)acrylate, polypropylene glycol (meth)acrylate, methoxyethylene glycol (meth)acrylate, and methoxypolypropylene glycol (meth)acrylate; and (meth)acrylate monomers such as fluoro(meth)acrylate, silicone (meth)acrylate, and 2-methoxyethyl acrylate.

The other monomer component may be used as needed to modify the base polymer. One or more of the other monomer components may be used. The content of the monomer unit derived from the other monomer component in the (meth)acrylic polymer is preferably from 0.1 to 40% by weight, more preferably from 0.5 to 30% by weight. If the content of the other monomer component is more than 50% by weight, it is not preferable from the viewpoint that the flexibility of the pressure-sensitive adhesive can be degraded.

A carboxyl group-containing monomer, specifically acrylic acid is preferably used as the other monomer component, because it can produce good adhesion. When the carboxyl group-containing monomer is used, the content of the carboxyl group-containing monomer unit may be from about 0.1 to about 10% by weight, preferably from 0.5 to 8% by weight, more preferably from 1 to 6% by weight. A hydroxyl group-containing monomer is also preferably used, because it can form a crosslinking point with an isocyanate crosslinking agent. When the hydroxyl group-containing monomer is used, the content of the hydroxyl group-containing monomer unit may be from about 0.1 to about 10% by weight, preferably from 0.5 to 8% by weight, more preferably from 1 to 6% by weight.

The (meth)acrylic polymer may be produced by a variety of known methods, for example, by a method appropriately selected from radical polymerization methods including a bulk polymerization method, a solution polymerization method and a suspension polymerization method. A variety of known radical polymerization initiators may be used such as azo initiators and peroxide initiators. The reaction is generally performed at a temperature of about 50 to about 80° C. for a time period of 1 to 8 hours. Among the above production methods, the solution polymerization method is preferred, in which ethyl acetate, toluene or the like is generally used as a solvent for the (meth)acrylic polymer. The concentration of the solution is generally from about 20 to about 80% by weight. The (meth)acrylic polymer may be obtained in the form of an aqueous emulsion.

The weight average molecular weight of the (meth)acrylic polymer may be from 800,000 to 3,000,000. The weight average molecular weight of the (meth)acrylic polymer is preferably from above 1,000,000 to 2,500,000, more preferably from 1,200,000 to 2,300,000. If the weight average molecular weight is less than 800,000, satisfactory results cannot be achieved with respect to the peripheral unevenness or durability. On the other hand, it is not preferred that the weight average molecular weight is more than 2,500,000, because the adhesion properties can be degraded. The content of low-molecular-weight polymers with a molecular weight of 100,000 or less in the (meth)acrylic polymer is preferably 15% by area or less. If the content of the low-molecular-weight polymers is kept low, the durability can be further improved. The content of the low-molecular-weight polymers is preferably 10% by area or less, more preferably 5% by area or less. In the process of synthesizing the polymer, the content of the low-molecular-weight polymers can be reduced by controlling the concentration, the initiator species and the amount thereof, and the polymerization temperature. A relatively high monomer concentration and a relatively low polymerization temperature are preferred. Specifically, when azobisisobutyronitrile or benzoyl peroxide is used as a initiator, such a low content can be achieved by a reaction at a polymerization temperature of about 50 to about 60° C. for a time period of about 8 hours. If the polymerization temperature is too low, the polymerization reaction cannot start. If the polymerization temperature is too high, low molecular components can increase so that the durability can be reduced. Also when an initiator is added again halfway through the polymerization, the low-molecular components can increase so that the peripheral unevenness can be worse.

The weight average molecular weight of the (meth)acrylic polymer was measured by gel permeation chromatography (GPC) under the following conditions: analyzer, HLC-8120GPC manufactured by Tosoh Corporation; column, G7000HXL+GMHXL+GMHXL manufactured by Tosoh Corporation; column size, each 7.8 mmφ×30 cm, 90 cm in total; column temperature, 40° C.; flow rate, 0.8 ml/minute; injection volume, 100 μl; eluent, tetrahydrofuran; detector, differential refractometer; standard sample, polystyrene. The content of polymers with a molecular weight of 100,000 or less was calculated as a weight fraction (% by area) from the result of the GPC measurement with a data processor (GPC-8020 manufactured by Tosoh Corporation). In this process, monomer components were not included.

The resin component (B) having an aromatic ring structure in its main chain is preferably a polyurethane resin, a polyimide resin and/or a polycarbonate resin, while it may be of any appropriate type as long as the effects of the present invention are not impaired.

The aromatic ring structure may be in any monomer component. Concerning a polyurethane resin, for example, at least one of the polyol component (or the polyol composition) and the isocyanate component may have the aromatic ring structure. The content of the monomer unit derived from the aromatic ring structure-containing monomer component in the resin component (B) having the aromatic ring structure in the main chain is preferably 40% by weight or more, more preferably 50% by weight or more, still more preferably 60% by weight or more.

The polyurethane resin (polyurethane polymer) in the present invention is a reaction product of a polyol component with a polyisocyanate component. More specifically, the polyurethane polymer may be synthesized by allowing a polyol compound to react with an isocyanate compound. Alternatively, any commercially available product may be used.

The polyol compound to be used according to the present invention may be a compound having two or more hydroxyl groups per molecule, such as polyether polyol and polyester polyol.

The polyol compound preferably has a number average molecular weight of 300 to 5000, more preferably of 500 to 4000. The polyol compound to be used preferably has 0.0005 to 0.003 equivalent/g of hydroxyl groups.

The polyether polyol may be an aliphatic polyether polyol or an aromatic polyether polyol. More specifically, polyethers produced by addition polymerization of ethylene oxide, propylene oxide, tetrahydrofuran, or the like with low molecular polyols such as dihydric alcohols such as ethylene glycol, diethylene glycol, propylene glycol, butylene glycol, and hexamethylene glycol; and trihydric alcohols such as trimethylolpropane, glycerin and pentaerythritol may be used. One or more of these polyether polyols may be used alone or in mixture.

The polyester polyol may be an aliphatic polyester polyol or an aromatic polyester polyol. More specifically, polyesters produced by polycondensation of a dibasic acid such as adipic acid, azelaic acid and sebacic acid with alcohols such as the above dihydric alcohols, dipropylene glycol, 1,4-butanediol, 1,6-hexanediol, and neopentylglycol may be used. One or more of these polyester polyols may be used alone or in mixture.

Polyol compounds also include polybutadiene and butadiene-acrylonitrile copolymers each having hydroxyl groups at both ends of the molecule, polydiene polyols such as polyisoprene polyols each having hydroxyl groups at both ends of the molecule, and polyolefin polyols such as hydrogenated polybutadiene, hydrogenated polyisoprene and polyisobutylene each having hydroxyl groups at both ends of the molecule.

Besides the polyol, if necessary, the polyol composition may further contain any of various known additives such as a crosslinking agent, a chain extender, a chain transfer agent, a reaction catalyst, a plasticizer, a filler, a reaction solvent, an antioxidant, an ultraviolet absorbing agent, an age resistor, a flame retardant, a colorant, an anti-foaming agent, and an antifungal or antimicrobial agent. One or more of these compounds may be used alone or in mixture.

The isocyanate compound in the present invention may be a polyisocyanate having two or more isocyanate groups. Any of known polyisocyanates for pressure-sensitive adhesives may be used.

For example, the polyisocyanate to be used may be an aromatic, aliphatic or alicyclic polyisocyanate. In particular, alicyclic diisocyanates such as isophorone diisocyanate, cyclohexane-1,4-diisocyanate, and 4,4-dicyclohexylmethane diisocyanate and aliphatic diisocyanates such as hexamethylene diisocyanate are preferably used in view of a quick reaction with the polyol composition and in view of suppression of a reaction with water. One or more of these polyisocyanates may be used alone or in mixture.

Some polyisocyanates may be yellowed by heating or during storage. In an embodiment of the present invention, therefore, non-yellowing type polyisocyanates are preferred. Specifically, polyisocyanates in which the isocyanate group is not directly bonded to the aromatic ring, aliphatic polyisocyanates and aromatic-aliphatic polyisocyanates are preferred. One or more of these polyisocyanates may be used alone or in mixture.

More specifically, preferred polyisocyanates include aliphatic isocyanate compounds such as hexamethylene diisocyanate (HDI), 1,3-bisisocyanatomethylcyclohexane (H6XDI), isophorone diisocyanate (IPDI), and 4,4′-dicyclohexylmethane diisocyanate (H12MDI); and aromatic aliphatic isocyanate compounds such as xylene diisocyanate (XDI), tetramethylxylene diisocyanate (TMXDI) and m-isopropenyl-α,α′-dimethylbenzyl isocyanate (TMI).

Based on the total amount of the hydroxyl groups of the polyol composition, 0.6 to 1.4 equivalents of the isocyanate compound may be used. Specifically, the isocyanate compound is preferably used such that the equivalent ratio (NCO/OH ratio) is from 0.6 to 1.4, particularly preferably from 0.8 to 1.2.

A catalyst such as dibutyltin dilaurate, tin octoate and 1,4-diazabicyclo[2,2,2]octane is preferably used for the reaction of the isocyanate group of the polyisocyanate with the hydroxyl group.

The polyurethane polymer preferably has a weight average molecular weight of 10,000 to 200,000, more preferably of 20,000 to 180,000, still more preferably of 30,000 to 150,000.

The weight average molecular weight of the polyurethane polymer was measured by gel permeation chromatography (GPC) under the following conditions: analyzer, HLC-8120GPC manufactured by Tosoh Corporation; column, G7000HXL+GMHXL+GMHXL manufactured by Tosoh Corporation; column size, each 7.8 mmφ×30 cm, 90 cm in total; column temperature, 40° C.; flow rate, 0.8 ml/minute; injection volume, 100 μl; eluent, tetrahydrofuran; detector, differential refractometer; standard sample, polystyrene. The content of polymers with a molecular weight of 100,000 or less was calculated as a weight fraction (% by area) from the result of the GPC measurement with a data processor (GPC-8020 manufactured by Tosoh Corporation). In this process, monomer components were not included.

The polyimide resin in the present invention may be a reaction product of a diamine component and a dicarboxylic acid (or tetracarboxylic acid) component. More specifically, the polyimide resin may be synthesized by allowing a tetracarboxylic anhydride to react with a diamine compound. Alternatively, any commercially available product may be used.

The polycarbonate resin in the present invention may be a polymer having a carbonate bond in its main chain, which may be a transesterification product of glycol and carbonate. Alternatively, any commercially available product may be used.

In the present invention, the pressure-sensitive adhesive layer may include, based on 100 parts by weight of the (meth)acrylic polymer (A), 20 to 200 parts by weight of, preferably 30 to 180 parts by weight of, more preferably 40 to 150 parts by weight of, still more preferably 50 to 120 parts by weight of the resin component (B) having an aromatic ring structure in its main chain. According to conventional techniques, for example, when 20 parts by weight or more of polyurethane elastomer is contained based on 100 parts by weight of a pressure-sensitive adhesive base polymer, a mixture can be whitened, and therefore, it has been difficult to find optical applications for such a mixture. However, it has been found that if a pressure-sensitive adhesive comprising a blend containing a certain amount of the resin component (B) having an aromatic ring structure in its main chain is used according to the present invention, a pressure-sensitive adhesive optical film having excellent performance with respect to durability and peripheral unevenness can be obtained.

Besides the (meth)acrylic polymer as a base polymer, the pressure-sensitive adhesive used to form the pressure-sensitive adhesive layer according to the present invention preferably contains a crosslinking agent. The crosslinking agent can improve durability and adhesion to optical films and maintain the shape of the pressure-sensitive adhesive itself and reliability at high temperature. Any appropriate crosslinking agent such as an isocyanate, epoxy, peroxide, metal chelate, or oxazoline crosslinking agent may be used. One or more of these crosslinking agents may be used alone or in combination. The crosslinking agent preferably has a functional group reactive with hydroxyl groups, and isocyanate crosslinking agents are particularly preferred.

Isocyanate compounds may be used as isocyanate crosslinking agents (C). Examples of the isocyanate compounds include isocyanate monomers such as tolylene diisocyanate, chlorophenylene diisocyanate, hexamethylene diisocyanate, tetramethylene diisocyanate, isophorone diisocyanate, xylylene diisocyanate, diphenylmethane diisocyanate, and hydrogenated diphenylmethane diisocyanate, and adduct type isocyanate compounds produced by adding the isocyanate monomer to trimethylolpropane or the like; and isocyanurate compounds, burette type compounds, and urethane prepolymer type isocyanates produced by addition reaction of or known polyether polyols, polyester polyols, acrylic polyols, polybutadiene polyols, polyisoprene polyols, or the like.

Examples of the epoxy crosslinking agent include bisphenol A-epichlorohydrin type epoxy resins. Examples of the epoxy crosslinking agent also include ethylene glycol diglycidyl ether, polyethylene glycol diglycidyl ether, glycerol diglycidyl ether, glycerol triglycidyl ether, 1,6-hexanediol diglycidyl ether, trimethylolpropane triglycidyl ether, diglycidylaniline, N,N,N′,N′-tetraglycidyl-m-xylylenediamine, 1,3-bis(N,N-diglycidylaminomethyl)cyclohexane, N,N,N′,N′-tetraglycidylaminophenylmethane, triglycidylisocyanurate, m-N,N-diglycidylaminophenyl glycidyl ether, N,N-diglycidyltoluidine, and N,N-diglycidylaniline.

Various types of peroxides may be used as the peroxide crosslinking agent. Examples of such peroxides include di(2-ethylhexyl)peroxydicarbonate, di(4-tert-butylcyclohexyl)peroxydicarbonate, di-sec-butylperoxydicarbonate, tert-butylperoxyneodecanoate, tert-hexylperoxypivalate, tert-butylperoxypivalate, dilauroyl peroxide, di-n-octanoyl peroxide, 1,1,3,3-tetramethylbutyl peroxyisobutylate, 1,1,3,3-tetramethylbutylperoxy-2-ethyl hexanoate, di(4-methylbenzoyl)peroxide, dibenzoyl peroxide, and tert-butylperoxyisobutylate. Above all, di(4-tert-butylcyclohexyl)peroxydicarbonate, dilauroyl peroxide and dibenzoyl peroxide are preferably used, because their crosslinking reaction efficiency is particularly good.

The crosslinking agent may be used in an amount of 10 parts by weight or less, preferably of 0.01 to 5 parts by weight, more preferably of 0.02 to 3 parts by weight, based on 100 parts by weight of the (meth)acrylic polymer (A). The use of more than 10 parts by weight of the crosslinking agent can provide excessive crosslinkage to reduce the adhesion and is not preferred.

If necessary, the pressure-sensitive adhesive of the present invention may conveniently contain various types of additives such as tackifiers, plasticizers, fillers comprising glass fibers, glass beads, metal power, or any other inorganic powder, pigments, colorants, fillers, antioxidants, ultraviolet absorbing agents, and silane coupling agents, without departing from the object of the present invention. The pressure-sensitive adhesive layer may also contain fine particles so as to have light diffusion properties.

The additive is preferably a silane coupling agent. Examples of the silane coupling agent include epoxy structure-containing silane coupling agents such as 3-glycidoxypropyltrimethoxysilane, 3-glycidoxypropylmethyldimethoxysilane, and 2-(3,4-epoxycyclohexyl)ethyltrimethoxysilane; amino group-containing silane coupling agents such as 3-aminopropyltrimethoxysilane, N-(2-aminoethyl)-3-aminopropyltrimethoxysilane, N-(2-aminoethyl)-3-aminopropylmethyldimethoxysilane, and 3-triethoxysilyl-N-(1,3-dimethylbutylidene)propylamine; (meth)acrylic group-containing silane coupling agents such as 3-acryloxypropyltrimethoxysilane and 3-methacryloxypropyltriethoxysilane; isocyanate group-containing silane coupling agents such as 3-isocyanatepropyltriethoxysilane; 3-chloropropyltrimethoxysilane; and acetoacetyl group-containing trimethoxysilane. A single silane coupling agent may be used alone, or a mixture of two or more silane coupling agents may be used. The amount of the addition of the silane coupling agent may be from 0.01 to 0.5 part by weight, preferably from 0.02 to 0.3 part by weight, based on 100 parts by weight of the (meth)acrylic polymer (A).

In the pressure-sensitive adhesive optical film of the present invention, the pressure-sensitive adhesive layer may be formed by the pressure-sensitive adhesive 20; on the discotic liquid crystal layer provided on the transparent base film. When an undercoat layer is provided on the discotic liquid crystal layer, the pressure-sensitive adhesive layer may be formed on the undercoat layer.

Examples of methods for forming the pressure-sensitive adhesive layer include, but are not limited to, a method including applying a pressure-sensitive adhesive solution to the discotic liquid crystal layer (or the undercoat layer) by any appropriate spreading method such as casting and coating, and drying it, and a method including forming the pressure-sensitive adhesive layer on a release sheet and transferring it from the release sheet. Coating methods that may be used include roll coating methods such as reverse coating and gravure coating and other coating methods such as spin coating methods, screen coating methods, fountain coating methods, dipping methods, and spray methods. After the pressure-sensitive adhesive solution is applied, the solvent or water may be evaporated by a drying process so that a pressure-sensitive adhesive layer with a desired thickness can be obtained.

The thickness of the pressure-sensitive adhesive layer may be appropriately determined depending on the application purpose, the adhesive strength or the like and is generally from 1 to 500 μm, preferably from 1 to 50 μm, more preferably from 1 to 40 μm, still more preferably from 5 to 30 μm, particularly preferably from 10 to 25 μm. A thickness of less than 1 μm can lead to poor durability. If the thickness is too thick, peeling off or separation can tend to occur due to foaming or the like so that the appearance can tend to be poor.

The pressure-sensitive adhesive layer containing the (meth)acrylic polymer may also be formed by applying a UV-curable pressure-sensitive adhesive syrup to a release film and irradiating the syrup with radiation such as UV and electron beam. In this case, the pressure-sensitive adhesive may contain a crosslinking agent so that reliability or retention of the shape of the pressure-sensitive adhesive itself can be achieved at high temperature.

The pressure-sensitive adhesive layer may be crosslinked in the drying or UV irradiation process. Alternatively, another crosslinking mode may also be chosen, in which aging by warming or standing at room temperature is performed so as to facilitate crosslinking after the drying.

Examples of constituent materials of a release sheet include: proper thin items such as paper; synthetic resin films made of polyethylene, polypropylene, polyethylene terephthalate; a rubber sheet, paper, cloth, unwoven fabric, net, a foam sheet and a metal foil, and a laminate thereof. In order to enhance releasability from a pressure-sensitive adhesive layer, a release treatment imparting a low adherence, such as a silicone treatment, a long chain alkylation treatment or a fluorination treatment, may be applied onto a surface of a release sheet when required.

In order to impart antistatic properties to the pressure-sensitive adhesive optical film, an antistatic agent may also be used. The antistatic agent may be added to each layer, or alternatively, an antistatic layer may be independently formed. Examples of the antistatic agent include ionic surfactants; electrically-conductive polymers such as polyaniline, polythiophene, polypyrrole, and polyquinoxaline; and metal oxides such as tin oxide, antimony oxide and indium oxide. In particular, electrically-conductive polymers are preferably used, in view of optical properties, appearance, antistatic effect, and stability of the antistatic effect during heating or humidifying. In particular, a water-soluble or dispersible electrically-conductive polymer such as polyaniline and polythiophene is preferably used, because when the water-soluble or dispersible electrically-conductive polymer is used as an antistatic layer-forming material in the coating process, the optical film substrate can be prevented from deteriorating due to an organic solvent.

As shown in FIG. 3, the optical film according to the present invention may include, and a polarizer 6 and a transparent protective film 7 that are laminated in this order on one side of a transparent base film 1 where the discotic liquid crystal layer 3 is not formed.

The polarizer 6 may be bonded to the transparent base film 1 with an adhesive. While the transparent base film 1 also serves as a transparent protective film for the polarizer 6 in FIGS. 2, 3 a polarizing plate including a polarizer and a transparent protective film laminated on one or both sides of the polarizer may be laminated on the transparent base film 1.

A polarizer is not limited especially but various kinds of polarizer may be used. As a polarizer, for example, a film that is uniaxially stretched after having dichromatic substances, such as iodine and dichromatic dye, absorbed to hydrophilic high molecular weight polymer films, such as polyvinyl alcohol type film, partially formalized polyvinyl alcohol type film, and ethylene-vinyl acetate copolymer type partially saponified film; poly-ene type alignment films, such as dehydrated polyvinyl alcohol and dehydrochlorinated polyvinyl chloride, etc. may be mentioned. In these, a polyvinyl alcohol type film on which dichromatic materials such as iodine, is absorbed and aligned after stretched is suitably used. Although thickness of polarizer is not especially limited, the thickness of about 5 to 80 μm is commonly adopted.

A polarizer that is uniaxially stretched after a polyvinyl alcohol type film dyed with iodine is obtained by stretching a polyvinyl alcohol film by 3 to 7 times the original length, after dipped and dyed in aqueous solution of iodine. If needed the film may also be dipped in aqueous solutions, such as boric acid and potassium iodide, which may include zinc sulfate, zinc chloride. Furthermore, before dyeing, the polyvinyl alcohol type film may be dipped in water and rinsed if needed. By rinsing polyvinyl alcohol type film with water, effect of preventing ununiformity, such as unevenness of dyeing, is expected by making polyvinyl alcohol type film swelled in addition that also soils and blocking inhibitors on the polyvinyl alcohol type film surface may be washed off. Stretching may be applied after dyed with iodine or may be applied concurrently, or conversely dyeing with iodine may be applied after stretching. Stretching is applicable in aqueous solutions, such as boric acid and potassium iodide, and in water bath.

As a materials forming the transparent protective film prepared on one side or both sides of the above-mentioned polarizer, with outstanding transparency, mechanical strength, heat stability, moisture cover property, isotropy, etc. may be preferable. The transparent protective film may be made of the same material as the transparent base film and may have the same thickness as the transparent base film.

The transparent base film and the transparent protective film may use the same or different polymer materials.

The polarizer, the transparent base film and the transparent protective film are generally bonded together with a water-based adhesive or the like interposed therebetween. Examples of the water-based adhesive include isocyanate adhesives, polyvinyl alcohol adhesives, gelatin adhesives, vinyl adhesives, latex adhesives, aqueous polyurethane adhesives, and aqueous polyester adhesives. Before the polarizer, the transparent base film and the transparent protective film are bonded together, the transparent base film and the transparent protective film may be subjected to activation treatment. Various methods such as saponification, corona treatment, low-pressure UV treatment, and plasma treatment may be used for the activation treatment. When the transparent base film is made of triacetylcellulose, norbornene resin, polycarbonate, or polyolefin resin, the activation treatment is particularly effective.

As the opposite side of the polarizing-adhering surface above-mentioned transparent protective film, a film with a hard coat layer and various processing aiming for antireflection, sticking prevention and diffusion or anti glare may be used.

A hard coat processing is applied for the purpose of protecting the surface of the polarization plate from damage, and this hard coat film may be formed by a method in which, for example, a curable coated film with excellent hardness, slide property etc. is added on the surface of the protective film using suitable ultraviolet curable type resins, such as acrylic type and silicone type resins. Antireflection processing is applied for the purpose of antireflection of outdoor daylight on the surface of a polarization plate and it may be prepared by forming an antireflection film according to the conventional method etc. Besides, a sticking prevention processing is applied for the purpose of adherence prevention with adjoining layer.

In addition, an anti glare processing is applied in order to prevent a disadvantage that outdoor daylight reflects on the surface of a polarization plate to disturb visual recognition of transmitting light through the polarization plate, and the processing may be applied, for example, by giving a fine concavo-convex structure to a surface of the protective film using, for example, a suitable method, such as rough surfacing treatment method by sandblasting or embossing and a method of combining transparent fine particle. As a fine particle combined in order to form a fine concavo-convex structure on the above-mentioned surface, transparent fine particles whose average particle size is 0.5 to 50 μm, for example, such as inorganic type fine particles that may have conductivity comprising silica, alumina, titania, zirconia, tin oxides, indium oxides, cadmium oxides, antimony oxides, etc., and organic type fine particles comprising cross-linked of non-cross-linked polymers may be used. When forming fine concavo-convex structure on the surface, the amount of fine particle used is usually about 2 to 50 weight parts to the transparent resin 100 weight parts that forms the fine concavo-convex structure on the surface, and preferably 5 to 25 weight parts. An anti glare layer may serve as a diffusion layer (viewing angle expanding function etc.) for diffusing transmitting light through the polarization plate and expanding a viewing angle etc.

In addition, the above-mentioned antireflection layer, sticking prevention layer, diffusion layer, anti glare layer, etc. may be built in the protective film itself, and also they may be prepared as an optical layer different from the protective film.

Besides the optical film including the polarizing plate laminated, as an optical film used for the pressure-sensitive adhesive optical film of the present invention, optical layers used for forming image displays such as liquid crystal display or the like, are used. For example, optical layers, such as a reflective plate, a transflective plate, a retardation plate (a half wavelength plate and a quarter wavelength plate included), and a viewing angle compensation film, which may be used for formation of a liquid crystal display or the likes are mentioned. These are used in practice as an optical film, or as one layer or two layers or more of optical layers laminated with polarizing plate.

Especially preferable polarizing plates are; a reflection type polarization plate or a transflective type polarization plate in which a reflective plate or a transflective reflective plate is further laminated onto a polarizing plate of the present invention; an elliptically polarizing plate or a circular polarizing plate in which a retardation plate is further laminated onto the polarizing plate; or a polarizing plate in which a brightness enhancement film is further laminated onto the polarizing plate.

A reflective layer is prepared on a polarization plate to give a reflection type polarization plate, and this type of plate is used for a liquid crystal display in which an incident light from a view side (display side) is reflected to give a display. This type of plate does not require built-in light sources, such as a backlight, but has an advantage that a liquid crystal display may easily be made thinner. A reflection type polarization plate may be formed using suitable methods, such as a method in which a reflective layer of metal etc. is, if required, attached to one side of a polarization plate through a transparent protective layer etc.

As an example of a reflection type polarization plate, a plate may be mentioned on which, if required, a reflective layer is formed using a method of attaching a foil and vapor deposition film of reflective metals, such as aluminum, to one side of a matte treated protective film. Moreover, a different type of plate with a fine concavo-convex structure on the surface obtained by mixing fine particle into the above-mentioned protective film, on which a reflective layer of concavo-convex structure is prepared, may be mentioned. The reflective layer that has the above-mentioned fine concavo-convex structure diffuses incident light by random reflection to prevent directivity and glaring appearance, and has an advantage of controlling unevenness of light and darkness etc. Moreover, the protective film containing the fine particle has an advantage that unevenness of light and darkness may be controlled more effectively, as a result that an incident light and its reflected light that is transmitted through the film are diffused. A reflective layer with fine concavo-convex structure on the surface effected by a surface fine concavo-convex structure of a protective film may be formed by a method of attaching a metal to the surface of a transparent protective layer directly using, for example, suitable methods of a vacuum evaporation method, such as a vacuum deposition method, an ion plating method, and a sputtering method, and a plating method etc.

Instead of a method in which a reflection plate is directly given to the protective film of the above-mentioned polarization plate, a reflection plate may also be used as a reflective sheet constituted by preparing a reflective layer on the suitable film for the transparent film. In addition, since a reflective layer is usually made of metal, it is desirable that the reflective side is covered with a protective film or a polarization plate etc. when used, from a viewpoint of preventing deterioration in reflectance by oxidation, of maintaining an initial reflectance for a long period of time and of avoiding preparation of a protective layer separately etc.

In addition, a transflective type polarizing plate may be obtained by preparing the above-mentioned reflective layer as a transflective type reflective layer, such as a half-mirror etc. that reflects and transmits light. A transflective type polarization plate is usually prepared in the backside of a liquid crystal cell and it may form a liquid crystal display unit of a type in which a picture is displayed by an incident light reflected from a view side (display side) when used in a comparatively well-lighted atmosphere. And this unit displays a picture, in a comparatively dark atmosphere, using embedded type light sources, such as a back light built in backside of a transflective type polarization plate. That is, the transflective type polarization plate is useful to obtain of a liquid crystal display of the type that saves energy of light sources, such as a back light, in a well-lighted atmosphere, and can be used with a built-in light source if needed in a comparatively dark atmosphere etc.

A description of the above-mentioned elliptically polarization plate or circularly polarization plate on which the retardation plate is laminated to the polarization plates will be made in the following paragraph. These polarization plates change linearly polarized light into elliptically polarized light or circularly polarized light, elliptically polarized light or circularly polarized light into linearly polarized light or change the polarization direction of linearly polarization by a function of the retardation plate. As a retardation plate that changes circularly polarized light into linearly polarized light or linearly polarized light into circularly polarized light, what is called a quarter wavelength plate (also called λ/4 plate) is used. Usually, half-wavelength plate (also called λ/2 plate) is used, when changing the polarization direction of linearly polarized light.

Elliptically polarization plate is effectively used to give a monochrome display without above-mentioned coloring by compensating (preventing) coloring (blue or yellow color) produced by birefringence of a liquid crystal layer of a super twisted nematic (STN) type liquid crystal display. Furthermore, a polarization plate in which three-dimensional refractive index is controlled may also preferably compensate (prevent) coloring produced when a screen of a liquid crystal display is viewed from an oblique direction. Circularly polarization plate is effectively used, for example, when adjusting a color tone of a picture of a reflection type liquid crystal display that provides a colored picture, and it also has function of antireflection.

As retardation plates, birefringence films obtained by uniaxial or biaxial stretching polymer materials, oriented films of liquid crystal polymers, and materials in which orientated layers of liquid crystal polymers are supported with films may be mentioned. Although a thickness of a retardation plate also is not especially limited, it is in general approximately from about 20 to 150 μm.

As polymer materials, for example, polyvinyl alcohols, polyvinyl butyrals, polymethyl vinyl ethers, poly hydroxyethyl acrylates, hydroxyethyl celluloses, hydroxypropyl celluloses, methyl celluloses, polycarbonates, polyarylates, polysulfones, polyethylene terephthalates, polyethylene naphthalates, polyethersulfones, polyphenylene sulfides, polyphenylene oxides, polyallyl sulfones, polyvinyl alcohols, polyamides, polyimides, polyolefins, polyvinyl chlorides, cellulose type polymers, or bipolymers, terpolymers, graft copolymers, blended materials of the above-mentioned polymers may be mentioned. These polymer raw materials make oriented materials (stretched film) using a stretching process and the like.

As liquid crystalline polymers, for example, various kinds of polymers of principal chain type and side chain type in which conjugated linear atomic groups (mesogens) demonstrating liquid crystalline orientation are introduced into a principal chain and a side chain may be mentioned. As examples of principal chain type liquid crystalline polymers, polymers having a structure where mesogen groups are combined by spacer parts demonstrating flexibility, for example, polyester based liquid crystalline polymers of nematic orientation property, discotic polymers, cholesteric polymers, etc. may be mentioned. As examples of side chain type liquid crystalline polymers, polymers having polysiloxanes, polyacrylates, polymethacrylates, or polymalonates as a principal chain structure, and polymers having mesogen parts comprising para-substituted ring compound units providing nematic orientation property as side chains via spacer parts comprising conjugated atomic groups may be mentioned. These liquid crystalline polymers, for example, is obtained by spreading a solution of a liquid crystal polymer on an orientation treated surface where rubbing treatment was performed to a surface of thin films, such as polyimide and polyvinyl alcohol, formed on a glass plate and or where silicon oxide was deposited by an oblique evaporation method, and then by heat-treating.

A retardation plate may be a retardation plate that has a proper retardation according to the purposes of use, such as various kinds of wavelength plates and plates aiming at compensation of coloring by birefringence of a liquid crystal layer and of visual angle, etc., and may be a retardation plate in which two or more sorts of retardation plates is laminated so that optical properties, such as retardation, may be controlled.

The above-mentioned elliptically polarization plate and an above-mentioned reflected type elliptically polarization plate are laminated plate combining suitably a polarization plate or a reflection type polarization plate with a retardation plate. This type of elliptically polarization plate etc. may be manufactured by combining a polarization plate (reflected type) and a retardation plate, and by laminating them one by one separately in the manufacture process of a liquid crystal display. On the other hand, the polarization plate in which lamination was beforehand carried out and was obtained as an optical film, such as an elliptically polarization plate, is excellent in a stable quality, a workability in lamination etc., and has an advantage in improved manufacturing efficiency of a liquid crystal display.

The polarization plate with which a polarization plate and a brightness enhancement film are adhered together is usually used being prepared in a backside of a liquid crystal cell. A brightness enhancement film shows a characteristic that reflects linearly polarization light with a predetermined polarization axis, or circularly polarization light with a predetermined direction, and that transmits other light, when natural light by back lights of a liquid crystal display or by reflection from a back-side etc., comes in. The polarization plate, which is obtained by laminating a brightness enhancement film to a polarization plate, thus does not transmit light without the predetermined polarization state and reflects it, while obtaining transmitted light with the predetermined polarization state by accepting a light from light sources, such as a backlight. This polarization plate makes the light reflected by the brightness enhancement film further reversed through the reflective layer prepared in the backside and forces the light re-enter into the brightness enhancement film, and increases the quantity of the transmitted light through the brightness enhancement film by transmitting a part or all of the light as light with the predetermined polarization state. The polarization plate simultaneously supplies polarized light that is difficult to be absorbed in a polarizer, and increases the quantity of the light usable for a liquid crystal picture display etc., and as a result luminosity may be improved. That is, in the case where the light enters through a polarizer from backside of a liquid crystal cell by the back light etc. without using a brightness enhancement film, most of the light, with a polarization direction different from the polarization axis of a polarizer, is absorbed by the polarizer, and does not transmit through the polarizer. This means that although influenced with the characteristics of the polarizer used, about 50 percent of light is absorbed by the polarizer, the quantity of the light usable for a liquid crystal picture display etc. decreases so much, and a resulting picture displayed becomes dark. A brightness enhancement film does not enter the light with the polarizing direction absorbed by the polarizer into the polarizer but reflects the light once by the brightness enhancement film, and further makes the light reversed through the reflective layer etc. prepared in the backside to re-enter the light into the brightness enhancement film. By this above-mentioned repeated operation, only when the polarization direction of the light reflected and reversed between the both becomes to have the polarization direction which may pass a polarizer, the brightness enhancement film transmits the light to supply it to the polarizer. As a result, the light from a backlight may be efficiently used for the display of the picture of a liquid crystal display to obtain a bright screen.

A diffusion plate may also be prepared between brightness enhancement film and the above described reflective layer, etc. A polarized light reflected by the brightness enhancement film goes to the above described reflective layer etc., and the diffusion plate installed diffuses passing light uniformly and changes the light state into depolarization at the same time. That is, the diffusion plate returns polarized light to natural light state. Steps are repeated where light, in the unpolarized state, i.e., natural light state, reflects through reflective layer and the like, and again goes into brightness enhancement film through diffusion plate toward reflective layer and the like. Diffusion plate that returns polarized light to the natural light state is installed between brightness enhancement film and the above described reflective layer, and the like, in this way, and thus a uniform and bright screen may be provided while maintaining brightness of display screen, and simultaneously controlling non-uniformity of brightness of the display screen. By preparing such diffusion plate, it is considered that number of repetition times of reflection of a first incident light increases with sufficient degree to provide uniform and bright display screen conjointly with diffusion function of the diffusion plate.

The suitable films are used as the above-mentioned brightness enhancement film. Namely, multilayer thin film of a dielectric substance; a laminated film that has the characteristics of transmitting a linearly polarized light with a predetermined polarizing axis, and of reflecting other light, such as the multilayer laminated film of the thin film; an aligned film of cholesteric liquid-crystal polymer; a film that has the characteristics of reflecting a circularly polarized light with either left-handed or right-handed rotation and transmitting other light, such as a film on which the aligned cholesteric liquid crystal layer is supported; etc. may be mentioned.

Therefore, in the brightness enhancement film of a type that transmits a linearly polarized light having the above-mentioned predetermined polarization axis, by arranging the polarization axis of the transmitted light and entering the light into a polarization plate as it is, the absorption loss by the polarization plate is controlled and the polarized light can be transmitted efficiently. On the other hand, in the brightness enhancement film of a type that transmits a circularly polarized light as a cholesteric liquid-crystal layer, the light may be entered into a polarizer as it is, but it is desirable to enter the light into a polarizer after changing the circularly polarized light to a linearly polarized light through a retardation plate, taking control an absorption loss into consideration. In addition, a circularly polarized light is convertible into a linearly polarized light using a quarter wavelength plate as the retardation plate.

A retardation plate that works as a quarter wavelength plate in a wide wavelength ranges, such as a visible-light region, is obtained by a method in which a retardation layer working as a quarter wavelength plate to a pale color light with a wavelength of 550 nm is laminated with a retardation layer having other retardation characteristics, such as a retardation layer working as a half-wavelength plate. Therefore, the retardation plate located between a polarization plate and a brightness enhancement film may consist of one or more retardation layers.

In addition, also in a cholesteric liquid-crystal layer, a layer reflecting a circularly polarized light in a wide wavelength ranges, such as a visible-light region, may be obtained by adopting a configuration structure in which two or more layers with different reflective wavelength are laminated together. Thus a transmitted circularly polarized light in a wide wavelength range may be obtained using this type of cholesteric liquid-crystal layer.

Moreover, the polarization plate may consist of multi-layered film of laminated layers of a polarization plate and two of more of optical layers as the above-mentioned separated type polarization plate. Therefore, a polarization plate may be a reflection type elliptically polarization plate or a semi-transmission type elliptically polarization plate, etc. in which the above-mentioned reflection type polarization plate or a transflective type polarization plate is combined with above described retardation plate respectively.

Although an optical film with the above described optical layer laminated to the polarizing plate may be formed by a method in which laminating is separately carried out sequentially in manufacturing process of a liquid crystal display etc., an optical film in a form of being laminated beforehand has an outstanding advantage that it has excellent stability in quality and assembly workability, etc., and thus manufacturing processes ability of a liquid crystal display etc. may be raised. Proper adhesion means, such as an adhesive layer, may be used for laminating. On the occasion of adhesion of the above described polarizing plate and other optical films, the optical axis may be set as a suitable configuration angle according to the target retardation characteristics etc.

In addition, ultraviolet absorbing property may be given to the above-mentioned each layer of the optical film, and the adhesive layer etc., of the pressure-sensitive adhesive optical film of the present invention, using a method of adding UV absorbents, such as salicylic acid ester type compounds, benzophenol type compounds, benzotriazol type compounds, cyano acrylate type compounds, and nickel complex salt type compounds.

The pressure-sensitive adhesive optical film of the present invention is preferably used to form various types of image displays such as liquid crystal displays. Liquid crystal displays may be formed according to conventional techniques. Specifically, liquid crystal displays are generally formed by appropriately assembling a liquid crystal cell and the pressure-sensitive adhesive optical film and optionally other components such as a lighting system and incorporating a driving circuit according to any conventional technique, except that the optical film of the present invention is used. Any type of liquid crystal cell may also be used such as a TN type, an STN type and π type.

Suitable liquid crystal displays, such as liquid crystal display with which the above pressure-sensitive adhesive optical film has been located at one side or both sides of the liquid crystal cell, and with which a backlight or a reflective plate is used for a lighting system may be manufactured. In this case, the optical film may be installed in one side or both sides of the liquid crystal cell. When installing the optical films in both sides, they may be of the same type or of different type. Furthermore, in assembling a liquid crystal display, suitable parts, such as diffusion plate, anti-glare layer, antireflection film, protective plate, prism array, lens array sheet, optical diffusion plate, and backlight, may be installed in suitable position in one layer or two or more layers.

Subsequently, organic electro luminescence equipment (organic EL display) will be explained. Generally, in organic EL display, a transparent electrode, an organic luminescence layer and a metal electrode are laminated on a transparent substrate in an order configuring an illuminant (organic electro luminescence illuminant). Here, a organic luminescence layer is a laminated material of various organic thin films, and much compositions with various combination are known, for example, a laminated material of hole injection layer comprising triphenylamine derivatives etc., a luminescence layer comprising fluorescent organic solids, such as anthracene; a laminated material of electronic injection layer comprising such a luminescence layer and perylene derivatives, etc.; laminated material of these hole injection layers, luminescence layer, and electronic injection layer etc.

An organic EL display emits light based on a principle that positive hole and electron are injected into an organic luminescence layer by impressing voltage between a transparent electrode and a metal electrode, the energy produced by recombination of these positive holes and electrons excites fluorescent substance, and subsequently light is emitted when excited fluorescent substance returns to ground state. A mechanism called recombination which takes place in a intermediate process is the same as a mechanism in common diodes, and, as is expected, there is a strong non-linear relationship between electric current and luminescence strength accompanied by rectification nature to applied voltage.

In an organic EL display, in order to take out luminescence in an organic luminescence layer, at least one electrode must be transparent. The transparent electrode usually formed with transparent electric conductor, such as indium tin oxide (ITO), is used as an anode. On the other hand, in order to make electronic injection easier and to increase luminescence efficiency, it is important that a substance with small work function is used for cathode, and metal electrodes, such as Mg—Ag and Al—Li, are usually used.

In organic EL display of such a configuration, an organic luminescence layer is formed by a very thin film about 10 nm in thickness. For this reason, light is transmitted nearly completely through organic luminescence layer as through transparent electrode. Consequently, since the light that enters, when light is not emitted, as incident light from a surface of a transparent substrate and is transmitted through a transparent electrode and an organic luminescence layer and then is reflected by a metal electrode, appears in front surface side of the transparent substrate again, a display side of the organic EL display looks like mirror if viewed from outside.

In an organic EL display containing an organic electro luminescence illuminant equipped with a transparent electrode on a surface side of an organic luminescence layer that emits light by impression of voltage, and at the same time equipped with a metal electrode on a back side of organic luminescence layer, a retardation plate may be installed between these transparent electrodes and a polarization plate, while preparing the polarization plate on the surface side of the transparent electrode.

Since the retardation plate and the polarization plate have function polarizing the light that has entered as incident light from outside and has been reflected by the metal electrode, they have an effect of making the mirror surface of metal electrode not visible from outside by the polarization action. If a retardation plate is configured with a quarter wavelength plate and the angle between the two polarization directions of the polarization plate and the retardation plate is adjusted to π/4, the mirror surface of the metal electrode may be completely covered.

This means that only linearly polarized light component of the external light that enters as incident light into this organic EL display is transmitted with the work of polarization plate. This linearly polarized light generally gives an elliptically polarized light by the retardation plate, and especially the retardation plate is a quarter wavelength plate, and moreover when the angle between the two polarization directions of the polarization plate and the retardation plate is adjusted to π/4, it gives a circularly polarized light.

This circularly polarized light is transmitted through the transparent substrate, the transparent electrode and the organic thin film, and is reflected by the metal electrode, and then is transmitted through the organic thin film, the transparent electrode and the transparent substrate again, and is turned into a linearly polarized light again with the retardation plate. And since this linearly polarized light lies at right angles to the polarization direction of the polarization plate, it cannot be transmitted through the polarization plate. As the result, mirror surface of the metal electrode may be completely covered.

### EXAMPLES

The present invention is more specifically described below using some examples which are not intended to limit the scope of the present invention.

### Example 1

### Preparation of Acrylic Polymer (a1)

To a four-neck flask equipped with a stirring blade, a thermometer, a nitrogen gas introducing tube, and a condenser were added 100 parts by weight of butyl acrylate (BA), 1 part by weight of 2-hydroxybutyl acrylate, 0.3 part by weight of 2,2′-azobisisobutyronitrile as a polymerization initiator, and 50 parts by weight of ethyl acetate. Nitrogen gas was introduced to sufficiently replace the air, while the mixture was gently stirred, and then a polymerization reaction was performed for 8 hours, while the temperature of the liquid in the flask was kept at about 55° C., so that a solution of an acrylic polymer (a1) was prepared. The acrylic polymer (a1) had a weight average molecular weight of 1,500,000.

(Preparation of Urethane Polymer (b1))

To a four-neck flask equipped with a stirring blade, a thermometer, a nitrogen gas introducing tube, and a condenser were added 75 parts by weight of polyoxytetramethylene glycol and 0.05 part by weight of dibutyltin laurate. Nitrogen gas was introduced to sufficiently replace the air, while the mixture was gently stirred, and then 25 parts by weight of xylylene diisocyanate was added dropwise. A polymerization reaction was performed for 2 hours, while the temperature of the liquid in the flask was kept at about 65° C., so that a urethane polymer (b1) was prepared. The urethane polymer (b1) had a weight average molecular weight of 100,000.

### (Preparation of Pressure-Sensitive Adhesive Composition)

To the acrylic polymer (a1) solution (based on 100 parts by weight of the solids of the acrylic polymer (a1) solution) were added 30 parts by weight of the urethane polymer (b1), 0.1 part by weight of a silane coupling agent of 3-glycidoxypropyltrimethoxysilane (KBM403 manufactured by Shin-Etsu Silicone Co., Ltd.) and 0.5 part by weight of a crosslinking agent of a trimethylolpropane/tolylene diisocyanate trimer adduct (Coronate L manufactured by Nippon Polyurethane Industry Co., Ltd.) and uniformly mixed and stirred so that an acrylic pressure-sensitive adhesive solution (1) was prepared.

### (Preparation of Pressure-Sensitive Adhesive Polarizing Plate)

The acrylic pressure-sensitive adhesive solution (1) was then applied to one side of a silicone-treated polyester film separator (38 μm in thickness) and dried at 130° C. for 3 minutes to thereby form a pressure-sensitive adhesive layer having a thickness of 25 μm after the drying.

The pressure-sensitive adhesive layer was bonded to the surface of the undercoat layer of the optical compensation layer-carrying polarizing film to form a pressure-sensitive adhesive optical film. The undercoat layer was prepared as an anchor coat layer with a coating amount of 0.2 cubic centimeters by a process including the steps of diluting Polyment NK-380 manufactured by Nippon Shokubai Co., Ltd. with toluene to a solids content of 0.2% by weight, adding 1 part by weight of a phenolic antioxidant IRGANOX 1010 manufactured by Ciba Specialty Chemicals Inc. to 100 parts by weight of the resulting solution to form a coating solution, applying the coating solution with a bar coater, and drying the coating solution.

### Example 2

A pressure-sensitive adhesive optical film was prepared using the same process of Example 1, except that 150 parts by weight of the urethane polymer (b1) was used in place of 30 parts by weight of the urethane polymer (b1).

### Example 3

A pressure-sensitive adhesive optical film was prepared using the same process of Example 1, except that the acrylic polymer (a2) described below was used in place of the acrylic polymer (a1).

(Preparation of Acrylic Polymer (a2))

To a four-neck flask equipped with a stirring blade, a thermometer, a nitrogen gas introducing tube, and a condenser were added 100 parts by weight of butyl acrylate (BA), 5 parts by weight of acrylic acid, 0.1 part by weight of 2-hydroxybutyl acrylate, 0.3 part by weight of 2,2′-azobisisobutyronitrile as a polymerization initiator, and 50 parts by weight of ethyl acetate. Nitrogen gas was introduced to sufficiently replace the air, while the mixture was gently stirred, and then a polymerization reaction was performed for 8 hours, while the temperature of the liquid in the flask was kept at about 55° C., so that a solution of an acrylic polymer (a2) was prepared. The acrylic polymer (a2) had a weight average molecular weight of 1,600,000.

### Example 4

A pressure-sensitive adhesive optical film was prepared using the same process of Example 1, except that 30 parts by weight of a polyamideimide resin (HPC-5000 manufactured by Hitachi Chemical Co., Ltd.) was used in place of 30 parts by weight of the urethane polymer (b1).

### Comparative Example 1

A pressure-sensitive adhesive optical film was prepared using the same process of Example 1, except that 10 parts by weight of the urethane polymer (b1) was used in place of 30 parts by weight of the urethane polymer (b1).

### Comparative Example 2

A pressure-sensitive adhesive optical film was prepared using the same process of Example 1, except that the urethane polymer (b1) was not used.

### Comparative Example 3

A pressure-sensitive adhesive optical film was prepared using the same process of Example 1, except that 250 parts by weight of the urethane polymer (b1) was used in place of 30 parts by weight of the urethane polymer (b1).

The resulting pressure-sensitive adhesive optical films were evaluated as described below. The results are shown in Table 1.

### (Peripheral Unevenness)

Two sample pieces (420 mm in length×320 mm in width) were prepared by cutting each pressure-sensitive adhesive optical film. The pressure-sensitive adhesive optical film samples were bonded with a laminator to both sides of a 0.07 mm-thick non-alkali glass plate in the crossed Nicol arrangement. The sample laminate was then subjected to autoclave treatment at 50° C. under 5 atm for 15 minutes. The sample laminate was then treated for 500 hours under each of the condition of 100° C. (heating) and the condition of 90% R.H. (humidifying) at 60° C. The sample laminate was then placed on a 10,000 candela backlight, and light leakage was visually evaluated according to the criteria below.

⊙: There is neither peripheral unevenness nor practical problem.
◯: Peripheral unevenness is slightly observed, but there is no practical problem.
Δ: Peripheral unevenness is observed, but there is no practical problem.
x: Peripheral unevenness is significantly observed to cause a practical problem.

### (Durability)

The pressure-sensitive adhesive optical film (15 inches in size) was attached to a non-alkali glass plate (Corning 1737 with a thickness of 0.7 mm) and subjected to treatment in an autoclave at 50° C. under 0.5 MPa for 15 minutes. The sample was then treated for 500 hours under each of the condition of 90° C. (heating) and the condition of 95% R.H. (humidifying) at 60° C. The sample was then visually evaluated according to the criteria below.

⊙: Neither separation, peeling off nor foaming occurs between the pressure-sensitive adhesive optical film and the non-alkali glass plate.
x: Separation, peeling off or foaming occurs between the pressure-sensitive adhesive optical film and the non-alkali glass plate.

TABLE 1

| | Peripheral Unevenness | | Durability | |
|---|---|---|---|---|
| | Heating | Humidifying | Heating | Humidifying |
| Example 1 | ⊙ | ⊙ | ◯ | ◯ |
| Example 2 | ◯ | ◯ | ◯ | ◯ |
| Example 3 | Δ | Δ | ◯ | ◯ |
| Example 4 | ◯ | ◯ | ◯ | ◯ |
| Comparative | X | X | X | X |
| Example 1 | | | | |
| Comparative | X | X | X | X |
| Example 2 | | | | |
| Comparative | ◯ | ◯ | X | X |
| Example 3 | | | | |

What is claimed is:

1. A pressure-sensitive adhesive optical film, comprising:
an optical film; and
a pressure-sensitive adhesive layer laminated on at least one side of the optical film,
wherein the pressure-sensitive adhesive layer is formed from a pressure-sensitive adhesive containing a (meth)acrylic polymer (A) and a resin component (B) having an aromatic ring structure in its main chain.

2. The pressure-sensitive adhesive optical film according to claim 1, wherein the pressure-sensitive adhesive contains 20 to 200 parts by weight of the resin component (B) having an aromatic ring structure in its main chain based on 100 parts by weight of the (meth)acrylic polymer (A).

3. The pressure-sensitive adhesive optical film according to claim 1, wherein the resin component (B) having an aromatic ring structure in its main chain is a polyurethane resin, a polyimide resin and/or a polycarbonate resin.

4. The pressure-sensitive adhesive optical film according to claim 1, wherein the pressure-sensitive adhesive further contains 0.1 to 10 parts by weight of (C) an isocyanate crosslinking agent and 0.01 to 0.5 part by weight of (D) a silane coupling agent, based on 100 parts by weight of the (meth)acrylic polymer (A).

5. The pressure-sensitive adhesive optical film according to claim 1, wherein the pressure-sensitive adhesive layer is laminated on the optical film with an undercoat layer interposed therebetween, and the undercoat layer contains a polymer (E), wherein the polymer (E) is a primary amino group-containing polymer.

6. The pressure-sensitive adhesive optical film according to claim 5, wherein the primary amino group-containing polymer is a poly(meth)acrylate ester having a primary amino group at its end.

7. The pressure-sensitive adhesive optical film according to claim 5, wherein the primary amino group-containing polymer comprises a polyethyleneimine material.

8. The pressure-sensitive adhesive optical film according to claim 5, wherein the undercoat layer comprises 0.01 to 500 parts by weight of an antioxidant based on 100 parts by weight of the polymer (E).

9. The pressure-sensitive adhesive optical film according to claim 8, wherein the antioxidant is at least one selected from a phenolic antioxidant, a phosphorus antioxidant, a sulfur antioxidant, and an amine antioxidant.

10. The pressure-sensitive adhesive optical film according to claim 5, wherein the optical film comprises a transparent base film and a discotic liquid crystal layer provided on one side of the transparent base film, and the pressure-sensitive adhesive layer is provided on the discotic liquid crystal layer with the undercoat layer interposed therebetween.

11. The pressure-sensitive adhesive optical film according to claim 10, wherein the optical film further comprises a polarizer that is provided on one side of the transparent base film on which the discotic liquid crystal layer is not provided.

12. An image display, comprising at least one piece of the pressure-sensitive adhesive optical film according to claim 1.
